(19) United States
(12) Patent Application Publication
(10) Pub. No.: US 2009/0011296 A1
(43) Pub. Date: Jan. 8, 2009

(54) Hydrogen generating apparatus and fuel cell power generation system

(75) Inventors: Hye-Yeon Cha, Seongnam-si (KR); Young-Soo Oh, Seongnam-si (KR); Jae-Hyuk Jang, Seongnam-si (KR); Chang-Ryul Jung, Seoul (KR); Bo-Sung Ku, Suwon-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRO-MECHANICS CO., LTD., Suwon (KR)

(21) Appl. No.: 12/216,151

(22) Filed: Jun. 30, 2008

(30) Foreign Application Priority Data
Jul. 2, 2007 (KR) 10-2007-0066055

(51) Int. Cl. H01M 8/18; B01J 19/00

(52) U.S. Cl. 429/19; 422/211

(57) ABSTRACT

A hydrogen generating apparatus and a fuel cell power generation system. An aspect of the invention provides a hydrogen generating apparatus for generating hydrogen through a dissociation reaction of an aqueous solution using electrons formed by an ionization of a metal. The hydrogen generating apparatus can include a chamber, which contains the aqueous solution, and in one side of which an outlet is formed to discharge the hydrogen; and a membrane, which is formed inside the chamber adjacent to the outlet, and which selectively permits the passage of the hydrogen. With certain embodiments of the invention, the overflowing of reagents can be prevented, for higher efficiency in the fuel cell. Because of the improvement in efficiency of the fuel cell power generation system, the volume of the system can be reduced, allowing for easier application to mobile devices.

### CROSS-REFERENCE TO RELATED APPLICATIONS

This application claims the benefit of Korean Patent Application No. 10-2007-0066055 filed with the Korean Intellectual Property Office on Jul. 2, 2007, the disclosure of which is incorporated herein by reference in its entirety.

### BACKGROUND

1. Technical Field

The present invention relates to a hydrogen generating apparatus and a fuel cell power generation system.

2. Description of the Related Art

A fuel cell is an apparatus that converts the chemical energies of fuel (hydrogen, LNQ LPQ methanol, etc.) and air directly into electricity and heat, by means of electrochemical reactions. In contrast to conventional power generation techniques, which employ the processes of burning fuel, generating vapor, driving turbines, and driving power generators, the utilization of fuel cells does not entail combustion processes or driving apparatus. As such, the fuel cell is an attractive new technology for generating power that offers high efficiency and few environmental problems.

FIG. 1 is a diagram illustrating the operating principle of a fuel cell.

Referring to FIG. 1, a fuel cell 100 may include a fuel electrode 110 as an anode and an air electrode 130 as a cathode. The fuel electrode 110 receives molecular hydrogen (H₂), which is dissociated into hydrogen ions (H⁺) and electrons (e⁻). The hydrogen ions move past an absorbent layer 120 towards the air electrode 130. This absorbent layer 120 corresponds to an electrolyte layer. The electrons move through an external circuit 140 to generate an electric current. The hydrogen ions and the electrons combine with the oxygen in the air at the air electrode 130 to generate water. The following Reaction Scheme 1 represents the chemical reactions described above.

### [Reaction Scheme 1]

Fuel Electrode 110: H₂→2H⁺+2e⁻

Air Electrode 130: ½O₂+2H⁺+2e⁻→H₂O

Overall Reaction: H₂+½O₂→H₂O

In short, the fuel cell can function as a battery, as the electrons dissociated from the fuel electrode 110 generate a current that passes through the external circuit. Such a fuel cell 100 is a pollution-free power source, because it does not produce any polluting emissions such as SOx, NOx, etc., and produces only little amounts of carbon dioxide. Also, the fuel cell may offer several other advantages, such as low noise and little vibration, etc.

In order for the fuel cell 100 to generate electrons at the fuel electrode 110, a hydrogen generating apparatus may be needed, which modifies a regular fuel containing hydrogen atoms into a gas having a high hydrogen content, as required by the fuel cell 100.

That is, examples of fuel cells being researched for application to portable electronic devices include the polymer electrolyte membrane fuel cell (PEMFC), which uses hydrogen as fuel, and the direct liquid fuel cell, such as the direct methanol fuel cell (DMFC), which uses liquid fuel directly. The PEMFC provides a high output density, but requires a separate apparatus for supplying hydrogen. Using a hydrogen storage tank, etc., for supplying the hydrogen can result in a large volume and can require special care in handling and keeping.

Because hydrogen exists as a gas at normal temperature, it entails very low storage efficiency. Using a pressurized tank for storing hydrogen may result in a very large volume for the fuel tank, whereas using an alloy for hydrogen storage may result in a very high mass. As such, the use of a hydrogen storage means may result in an increased size or mass of the overall fuel cell system, and thus may be difficult to utilize in portable electronic devices.

In accordance with rapid developments toward smaller size and multi-functionality in portable electronic devices, satisfying the demands for higher efficiency and longer operation times in power supply devices has been the focus of many current fields of research. In this context, the fuel cell, which converts chemical energy directly into electrical energy, is growing in importance as a new means of radically increasing efficiency and life span.

Research on methods of generating and supplying hydrogen, which serves as the fuel necessary for operating a fuel cell, can be seen as a foundation for increasing the efficiency of the fuel cell. Thus, numerous studies have been conducted on such methods of hydrogen generation and supply, ever since the onset of fuel cell technology.

In methods of supplying a fuel cell with hydrogen, the method of injecting hydrogen directly may be advantageous in terms of reducing energy losses, but due to difficulties in storing hydrogen as well as the safety hazards involved, this method is employed only in a limited number of fields, including fields of transport vehicles and power generation. In general, a portable electronic device may utilize the hydrogen conversion process of a reformer to generate hydrogen.

A reforming reaction that uses water can be utilized for generating hydrogen. With this method, however, when the hydrogen generated inside the reactor is transferred to the fuel cell, water, which is one of the reagents, may be transferred as a vapor together with the hydrogen, to dramatically lower the efficiency of the fuel cell.

### SUMMARY

An aspect of the invention provides a hydrogen generating apparatus and a fuel cell power generation system, in which overflowing of the reagents in the hydrogen generation reaction can be prevented, to increase the efficiency of the fuel cell power generation system.

Another aspect of the invention provides a hydrogen generating apparatus for generating hydrogen through a dissociation reaction of an aqueous solution using electrons formed by an ionization of a metal. The hydrogen generating apparatus can include a chamber, which contains the aqueous solution, and in one side of which an outlet is formed to discharge the hydrogen; and a membrane, which is formed inside the chamber adjacent to the outlet, and which selectively permits the passage of the hydrogen.

A membrane brace can be formed between the aqueous solution and the membrane, so as to support the membrane. The membrane brace can be such that allows the hydrogen to pass through while preventing the aqueous solution from passing through.

Also, an adhesion layer can be formed between the membrane brace and the membrane, so as to secure the membrane. A hydrogen transport tube can be formed in the membrane brace, where the hydrogen transport tube can secure the adhesion layer and transport the hydrogen.

The adhesion layer can be made of a polymer material, such as rubber, for example, and the membrane can be made of a polytetrafluoroethylene (PTFE) film.

Yet another aspect of the invention provides a fuel cell power generation system that uses as fuel the hydrogen generated through a dissociation reaction of an aqueous solution using electrons formed by an ionization of a metal. The fuel cell power generation system can include a hydrogen generating apparatus and a fuel cell. The hydrogen generating apparatus can include a chamber, which contains the aqueous solution, and in one side of which an outlet is formed to discharge the hydrogen; and a membrane, which is formed inside the chamber adjacent to the outlet, and which selectively permits the passage of the hydrogen. The fuel cell can be such that produces an electrical current by receiving the hydrogen generated by the hydrogen generating apparatus and converting the chemical energy of the hydrogen into electrical energy.

A membrane brace can be formed between the aqueous solution and the membrane, so as to support the membrane. The membrane brace can be such that allows the hydrogen to pass through while preventing the aqueous solution from passing through.

Also, an adhesion layer can be formed between the membrane brace and the membrane, so as to secure the membrane. A hydrogen transport tube can be formed in the membrane brace, where the hydrogen transport tube can secure the adhesion layer and transport the hydrogen.

The adhesion layer can be made of a polymer material, such as rubber, for example, and the membrane can be made of a polytetrafluoroethylene (PTFE) film.

Additional aspects and advantages of the present invention will be set forth in part in the description which follows, and in part will be obvious from the description, or may be learned by practice of the invention.

### BRIEF DESCRIPTION OF THE DRAWINGS

FIG. 1 is a diagram schematically illustrating the operational principle of a typical fuel cell.

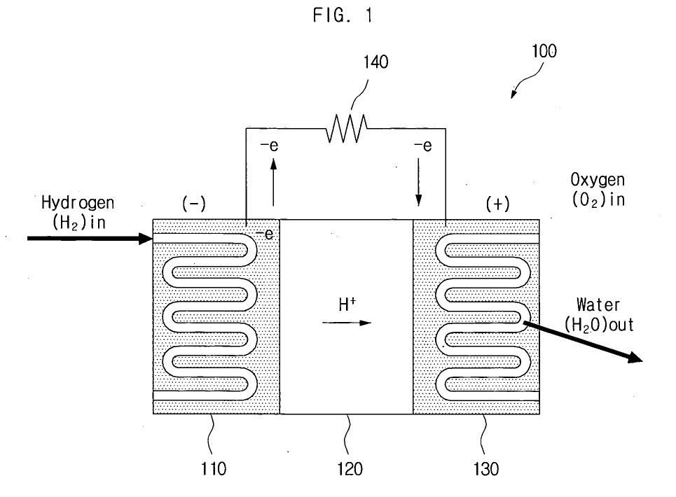

FIG. 2 is a diagram schematically illustrating a hydrogen generating apparatus.

FIG. 3 is a cross sectional view of a hydrogen generating apparatus according to a first disclosed embodiment of the invention.

FIG. 4 is a cross sectional view of a hydrogen generating apparatus according to a second disclosed embodiment of the invention.

FIG. 5 is a cross sectional view of a hydrogen generating apparatus according to a third disclosed embodiment of the invention.

FIG. 6 is an exploded perspective view of a hydrogen generating apparatus according to a first disclosed embodiment of the invention.

### DETAILED DESCRIPTION

As the invention allows for various changes and numerous embodiments, particular embodiments will be illustrated in drawings and described in detail in the written description. However, this is not intended to limit the present invention to particular modes of practice, and it is to be appreciated that all changes, equivalents, and substitutes that do not depart from the spirit and technical scope of the present invention are encompassed in the present invention. In the description of the present invention, certain detailed explanations of related art are omitted when it is deemed that they may unnecessarily obscure the essence of the invention.

While such terms as “first” and “second,” etc., may be used to describe various components, such components must not be limited to the above terms. The above terms are used only to distinguish one component from another. For example, a first component may be referred to as a second component without departing from the scope of rights of the present invention, and likewise a second component may be referred to as a first component. The term “and/or” encompasses both combinations of the plurality of related items disclosed and any one item from among the plurality of related items disclosed.

When a component is mentioned to be “connected to” or “accessing” another component, this may mean that it is directly formed on or stacked on the other component, but it is to be understood that another element may exist in-between. On the other hand, when a component is mentioned to be “directly connected to” or “directly accessing” another component, it is to be understood that there are no other elements in-between.

The terms used in the present application are merely used to describe particular embodiments, and are not intended to limit the present invention. An expression used in the singular encompasses the expression of the plural, unless it has a clearly different meaning in the context. In the present application, it is to be understood that the terms such as “including” or “having,” etc., are intended to indicate the existence of the features, numbers, steps, actions, components, parts, or combinations thereof disclosed in the specification, and are not intended to preclude the possibility that one or more other features, numbers, steps, actions, components, parts, or combinations thereof may exist or may be added.

Unless otherwise defined, all terms used herein, including technical or scientific terms, have the same meanings as those generally understood by those with ordinary knowledge in the field of art to which the present invention belongs. Such terms as those defined in a generally used dictionary are to be interpreted to have the meanings equal to the contextual meanings in the relevant field of art, and are not to be interpreted to have ideal or excessively formal meanings unless clearly defined in the present application.

Certain embodiments of the invention will now be described below in more detail with reference to the accompanying drawings.

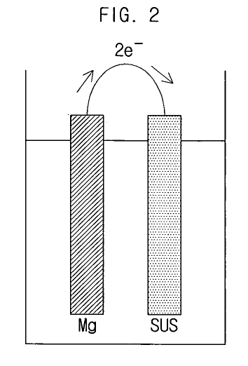

Methods used in generating hydrogen for a polymer electrolyte membrane fuel cell (PEMFC) can be divided mainly into methods that use the oxidation of aluminum, methods that use the hydrolysis of metal borohydrides, and methods that use reactions on metal electrodes. Among these methods, methods of using metal electrodes can be more advantageous in terms of efficiently adjusting the rate of hydrogen generation. FIG. 2 is a schematic diagram illustrating a hydrogen generating apparatus that uses metal electrodes.

In the example illustrated in the drawing, an anode made of magnesium and a cathode made of stainless steel are dipped in an electrolyte solution inside an electrolyte bath.

The basic principle of the hydrogen generating apparatus is that electrons are generated at the magnesium electrode, which has a greater tendency to ionize than the stainless steel electrode, and the generated electrons travel to the stainless steel electrode. The electrons can then react with the aqueous electrolyte solution to generate hydrogen.

The following Reaction Scheme 2 represents the chemical reactions in the hydrogen generating apparatus 200 described above.

### [Reaction Scheme 2]

Anode: Mg→Mg²⁺+2e⁻

Cathode: 2H₂O+2e⁻→H₂+2(OH)⁻

Overall Reaction Mg+2H₂O→Mg²⁺+H₂+2(OH)⁻

This is a method in which the electrons obtained when magnesium in the electrode is ionized to Mg²⁺ ions are moved through a wire to another metal object (e.g. aluminum or stainless steel), where hydrogen is generated by the dissociation of water. The amount of hydrogen generated can be regulated on demand, as it is related to the flow of electricity, the distance between electrodes, and the sizes of the electrodes.

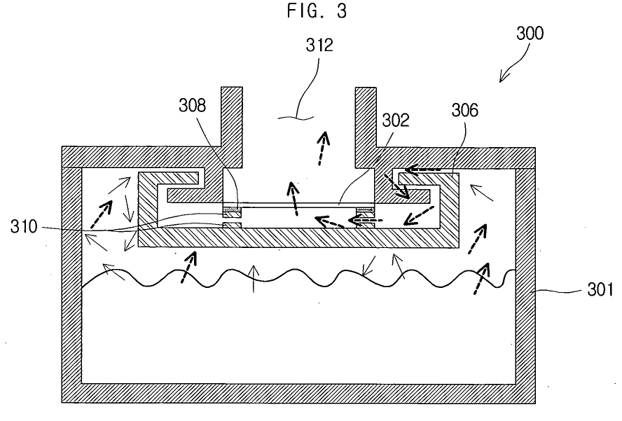

FIG. 3 is a cross sectional view of a hydrogen generating apparatus according to a first disclosed embodiment of the invention. As in the example illustrated in FIG. 3, a hydrogen generating apparatus 300 can include a chamber 301, a membrane 302, a membrane brace 306, an adhesion layer 308, hydrogen transport tubes 310, and an outlet 312.

In this embodiment, hydrogen can be generated using the principle of the hydrogen generating apparatus having metal electrodes illustrated with reference to FIG. 2. In other words, the hydrogen generating apparatus 300 may generate hydrogen through the dissociation reaction of an aqueous solution, using electrons obtained when a metal is ionized.

An aqueous solution and metal pieces can be held inside the chamber 301. That is, a metal such as magnesium immersed in the aqueous solution may be ionized, at which the electrons obtained from the ionization may travel through a wire to a metal such as aluminum or stainless steel, to react with water and generate hydrogen.

An outlet 312 may be formed in one side of the chamber 301 through which to discharge the generated hydrogen.

This particular embodiment will be described for an example in which the metal electrodes are of magnesium and stainless steel, and the water exists as a liquid. The desired product of the reaction is hydrogen gas, where the water may also be included as a vapor.

Also, as the reaction progresses, the pressure inside the hydrogen generating apparatus 300 may increase, creating a risk of overflowing, in which the reagents contained inside are ejected to the outside. The occurrence of an overflowing of the reagents means that less than 100% of the reagents will be used, resulting in lowered system efficiency.

The efficiency of a system is a very important factor in mobile devices. If the system has a low efficiency, it may be necessary to increase the volume of the system to provide a desired level of performance. This may incur increases in size and mass for the overall device, greatly hindering portability.

Therefore, it is an important to prevent the overflowing of the internal reagents and thereby enhance system efficiency, in order to make the system a commercial success.

To this end, a membrane 302 can be formed inside the chamber 301 adjacent to the outlet 312 of the hydrogen generating apparatus 300 that selectively allows hydrogen to pass through. Here, the membrane 302 can be made of a polytetrafluoroethylene (PTFE) film. It is apparent that the PTFE film serves as a membrane in various fields of technology and is useful for filtering various substances.

The membrane 302 can also serve as a filter that allows hydrogen to permeate through but disallows the passage of water vapor. Thus, when the hydrogen generated inside the hydrogen generating apparatus 300 is transferred to the fuel cell, the aqueous solution, which is one of the reagents, is prevented from being transferred together in the form of a vapor and hence from lowering the efficiency.

Although a PTFE film may serve well as the membrane, its filtering performance may rapidly decline if the PTFE film comes into direct contact with a liquid. As such, it may not be possible to prevent the overflowing of reagents simply by installing the PTFE film onto the outlet 312.

To prevent the aqueous solution from directly touching the membrane 302, which may or may not be a PTFE film, a membrane brace 306 can be formed supporting the membrane 302, between the aqueous solution and the membrane 302. The membrane brace 306 can be such that allows hydrogen to pass but prevents the aqueous solution from passing. That is, when proceeding with a reaction for generating hydrogen in an aqueous solution containing magnesium and stainless steel electrodes, the membrane brace 306 can serve primarily to prevent the aqueous solution from touching the membrane 302 and secondarily to perform a filtering action by allowing the passage of hydrogen and blocking the passage of the aqueous solution.

An adhesion layer 308 can be placed between the membrane brace 306 and the membrane 302 and can be attached to the membrane 302 for securing the membrane 302. Here, the adhesion layer 308 can be made of a polymer material, such as rubber, for example.

Hydrogen transport tubes 310 can be formed in the membrane brace 306 to secure the adhesion layer 308. A hydrogen transport tube 310 can be implemented in a tubular shape, through which to transport hydrogen.

To provide a more specific example, a membrane brace 306 can be formed inside the chamber 301 not to contact the aqueous solution, and hydrogen transport tubes 310 can be formed inside the membrane brace 306 in directions that do not lead to contact with the aqueous solution.

An adhesion layer 308 can be formed that has one side touching the hydrogen transport tubes 310, and a membrane 302 can be formed that touches the other side of the adhesion layer 308.

Thus, the hydrogen transport tubes 310 may serve as transport channels for the hydrogen generated by the reaction, so that the hydrogen passing through the membrane brace 306 may be moved to the membrane 302.

Of course, the hydrogen transport tubes 310 are not limited to tubular shapes, and can be fabricated to various forms that allow the passage of air.

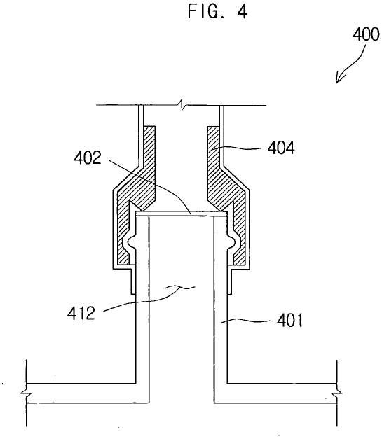

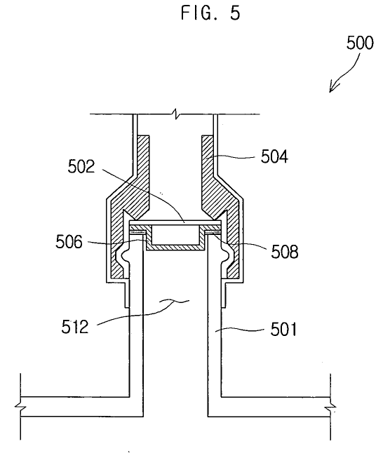

FIG. 4 is a cross sectional view of a hydrogen generating apparatus according to a second disclosed embodiment of the invention, and FIG. 5 is a cross sectional view of a hydrogen generating apparatus according to a third disclosed embodiment of the invention.

As in the example illustrated in FIG. 4, a hydrogen generating apparatus 400 can include a chamber 401, a membrane 402, a fuel cell connector 404, and an outlet 412. The membrane 402 can be formed adjacent to the fuel cell connector 404, through which hydrogen may be transferred from the hydrogen generating apparatus 400 to the fuel cell. The outlet 412 and the fuel cell connector 404 can be in contact with the membrane 402. This hydrogen generating apparatus 400 may be applied to those cases where there is not much overflowing of the reagents.

In the example illustrated in FIG. 5, the hydrogen generating apparatus 500 may include a chamber 501, an outlet 512, a membrane brace 506, an adhesion layer 508, a membrane 502, and a fuel cell connector 504. FIG. 5 illustrates a membrane brace 506 that touches and supports the membrane 502, in addition to the components of the hydrogen generating apparatus 400 illustrated in FIG. 4. Therefore, the membrane 502 can be prevented from coming into contact with the reagents in the event of an overflow.

Also, an adhesion layer 508 can be placed between the membrane brace 506 and the chamber 501, by which to secure the membrane brace 506 to the chamber 501. This hydrogen generating apparatus 500 may be applied to those cases where there is not much overflowing of the reagents. The membrane 502 and the membrane brace 506 can be formed in the portion where the chamber 501 is connected to the fuel cell connector 504.

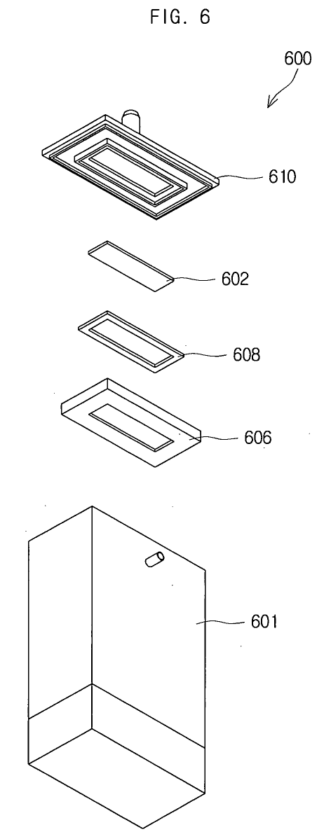

FIG. 6 is an exploded perspective view of a hydrogen generating apparatus according to the first disclosed embodiment of the invention. In FIG. 6, there are illustrated a chamber 601, a membrane brace 606, an adhesion layer 608, a membrane 602, and a cover 610. As illustrated in the drawing, a membrane brace 606 can be housed inside the chamber 601, while an adhesion layer 608 and a membrane 602 can be housed within the membrane brace 606, and a cover 610 can be engaged over the chamber 601. An outlet in the cover 610 can be connected to a fuel cell.

It is to be appreciated that aspects of the invention also provide a fuel cell power generation system that includes the fuel cell, which is supplied with the hydrogen generated in the hydrogen generating apparatus described above, and which converts the chemical energy of the hydrogen to electrical energy to produce a direct electrical current.

As set forth above, in a hydrogen generating apparatus based on a certain embodiment of the invention, overflowing of the reagents in the hydrogen generating reaction can be prevented, for higher efficiency in the fuel cell.

With the improvement in efficiency of the fuel cell power generation system, the volume of the system can be reduced, allowing for easier application to mobile devices.

Furthermore, system efficiency can be increased by way of a simple process using a polytetrafluoroethylene (PTFE) film.

Also, fuel efficiency can be improved, as pure hydrogen gas can be supplied to the fuel cell after a twofold filtering by the membrane brace and the membrane.

While the spirit of the invention has been described in detail with reference to particular embodiments, the embodiments are for illustrative purposes only and do not limit the invention. It is to be appreciated that those skilled in the art can change or modify the embodiments without departing from the scope and spirit of the invention. As such, many embodiments other than those set forth above can be found in the appended claims.

What is claimed is:

1. A hydrogen generating apparatus for generating hydrogen through a dissociation reaction of an aqueous solution using electrons obtained by an ionization of a metal, the hydrogen generating apparatus comprising:
a chamber containing the aqueous solution and having an outlet formed in one side thereof, the outlet configured to discharge the hydrogen; and
a membrane formed inside the chamber adjacent to the outlet, the membrane selectively permitting passage for the hydrogen.

2. The hydrogen generating apparatus of claim 1, further comprising:
a membrane brace interposed between the aqueous solution and the membrane so as to support the membrane, the membrane brace permitting passage for the hydrogen and preventing passage for the aqueous solution.

3. The hydrogen generating apparatus of claim 2, further comprising:
an adhesion layer interposed between the membrane brace and the membrane, the adhesion layer securing the membrane.

4. The hydrogen generating apparatus of claim 3, wherein the membrane brace comprises a hydrogen transport tube formed therein, the hydrogen transport tube securing the adhesion layer and transporting the hydrogen.

5. The hydrogen generating apparatus of claim 3, wherein the adhesion layer is made of a polymer material.

6. The hydrogen generating apparatus of claim 5, wherein the polymer material comprises rubber.

7. The hydrogen generating apparatus of claim 1, wherein the membrane comprises a polytetrafluoroethylene (PTFE) film.

8. A fuel cell power generation system using as fuel hydrogen generated through a dissociation reaction of an aqueous solution using electrons obtained by an ionization of a metal, the fuel cell power generation system comprising:
a hydrogen generating apparatus comprising a chamber and a membrane,
wherein the chamber contains the aqueous solution and has an outlet formed in one side thereof, the outlet configured to discharge the hydrogen,
and wherein the membrane is formed inside the chamber adjacent to the outlet, the membrane selectively permitting passage for the hydrogen; and
a fuel cell configured to produce an electrical current by receiving the hydrogen generated by the hydrogen generating apparatus and converting chemical energy of the hydrogen into electrical energy.

9. The fuel cell power generation system of claim 8, further comprising:
a membrane brace interposed between the aqueous solution and the membrane so as to support the membrane, the membrane brace permitting passage for the hydrogen and preventing passage for the aqueous solution.

10. The fuel cell power generation system of claim 9, further comprising:
an adhesion layer interposed between the membrane brace and the membrane, the adhesion layer securing the membrane.

11. The fuel cell power generation system of claim 10, wherein the membrane brace comprises a hydrogen transport tube formed therein, the hydrogen transport tube securing the adhesion layer and transporting the hydrogen.

12. The fuel cell power generation system of claim 10, wherein the adhesion layer is made of a polymer material.

13. The fuel cell power generation system of claim 12, wherein the polymer material comprises rubber.

14. The fuel cell power generation system of claim 8, wherein the membrane comprises a polytetrafluoroethylene (PTFE) film.
